(19) United States
(12) Patent Application Publication
(10) Pub. No.: US 2014/0301796 A1
(43) Pub. Date: Oct. 9, 2014

(54) TOOL AND METHOD FOR CUTTING THREAD PRODUCTION

(71) Applicant: EMUGE-Werk Richard Glimpel GmbH & Co. KG Fabrik fuer Praezisionswerkzeuge, Lauf a.d. Pegnitz (DE)

(72) Inventors: Helmut Glimpel, Lauf a.d. Pegnitz (DE); Stefan Fenn, Reichenschwand (DE)

(73) Assignee: EMUGE-Werk Richard Glimpel GmbH & Co. KG Fabrik fuer Praezisionswerkzeuge, Lauf a.d. Pegnitz (DE)

(21) Appl. No.: 14/242,730

(22) Filed: Apr. 1, 2014

(30) Foreign Application Priority Data
Apr. 9, 2013 (DE) 102013103538.8

(51) Int. Cl. B23G 5/06

(52) U.S. Cl. CPC B23G 5/06; B23G 2200/34; B23G 2210/04
USPC 408/1 R; 408/223; 408/224

(57) ABSTRACT

A tap for cutting thread production can include a working region that is rotatable about a tool axis, and has a plurality of cutting teeth arranged on the tool circumference, wherein each cutting tooth has a cutting tooth head at a region that is radially farthest from the tool axis. The radial distance of the cutting tooth heads from the tool axis is substantially the same or decreases counter to an intended feed direction of the tool in a guide region of the working region, but increases counter to the intended feed direction of the tool in a starting region of the working region. Thus, in an axial cross section, the superimposed profiles of axially spaced-apart cutting teeth have a profile differential area. The radial cutting tooth profile boundary of the cutting teeth can be at least sectionally curved in the starting region.

### CROSS-REFERENCE TO RELATED APPLICATIONS

The present invention claims the benefit of priority to German Patent Application No. 10 2013 103 538.8 filed Apr. 9, 2013 entitled “Tool and Method for Cutting Thread Production,” the entire content of which is incorporated herein by reference.

### BACKGROUND OF THE INVENTION

1. The Field of the Invention

This invention relates to a tool and method for cutting thread production, in particular a tap.

2. Background and Relevant Art

A tool for cutting thread production generally comprises at least one working region that is rotatable or rotated about a tool axis and has a plurality of cutting teeth arranged on the tool circumference. Each cutting tooth has a cutting tooth head at its point or region that is radially farthest from the tool axis. The radial distance of the cutting tooth heads from the tool axis is substantially the same or decreases counter to an intended feed direction of the tool in a guide region of the working region. The radial distance of the cutting tooth heads from the tool axis increases counter to the intended feed direction of the tool in a starting region, located in front of the guide region in the intended feed direction, of the working region, such that, in an axial cross section, the superimposed profiles of axially spaced-apart cutting teeth have a profile differential area.

If two axially spaced-apart cutting teeth act directly in succession on the same point of a workpiece, then the cross section of the chip removed by the following cutting tooth corresponds at least substantially to the profile differential area of the two cutting teeth.

A cutting tooth is not only axially offset with respect to a further cutting tooth when both cutting teeth are arranged in a manner spaced apart from one another along a line parallel to the tool axis. Rather, two cutting teeth that are arranged in an offset manner in the direction of the tool circumference are understood to be cutting teeth that are axially offset with respect to one another if an axial offset is present in addition to the offset in the circumferential direction.

For thread production or thread rework, both cutting and chipless methods and threading tools are known. Cutting thread production is based on removal of the material of the workpiece in the region of the thread turn. Chipless thread production is based on forming of the workpiece and production of the thread turn in the workpiece by pressure. An overview of the thread-producing tools and working methods in use is given in the Handbuch der Gewindetechnik and Frastechnik [Manual of threading and milling technology], publisher: EMUGE-FRANKEN, publishing company: Publicis Corporate Publishing, year of publication: 2004 (ISBN 3-89578-232-7), designated only as “EMUGE manual” in the following text.

Cutting thread-producing tools include taps (cf. EMUGE manual, Chapter 8, pages 181 to 298) and thread milling cutters (cf. EMUGE manual, Chapter 10, pages 325 to 372) and also, for external threads only, thread-cutting dies (cf. EMUGE manual, Chapter 11, pages 373 to 404).

A tap is a thread-cutting tool having cutting teeth (also known as thread-cutting teeth, cutting edges). The cutting teeth generally remove chips from the material to be machined during thread production. In one type of taps, the cutting teeth are arranged along an external thread at the thread pitch of the thread to be produced. When an internal thread is produced, this type of tap is moved with an axial feed motion with respect to the tool axis, and while being rotated about its tool axis at a rotational speed dependent on the axial feed speed in a manner corresponding to the thread pitch, into a cylindrical core hole in a workpiece, wherein the tool axis of the tap is oriented coaxially with the centre axis of the core hole and its cutting teeth are permanently in engagement with the workpiece at the core hole wall (continuous cut), so that a continuous thread turn is produced on the core hole wall. In another type of taps, in each case two or more cutting teeth are arranged in planes perpendicularly to the tool axis, wherein these planes are spaced apart from one another, specifically in a manner corresponding to the pitch of the thread to be produced.

The cutting teeth, in particular the cutting teeth in the starting region, are subjected to a high degree of wear, in particular at the peripheries or edges of the cutting tooth head.

### BRIEF SUMMARY OF THE INVENTION

Implementations of the present invention include a tool configured such that the wear to the cutting teeth is reduced. Furthermore, a method for cutting thread production using this tool is intended to be specified.

With regard to the tool, such implementations can be achieved by the features disclosed herein, and recited in the claims. Advantageous configurations and developments are specified and claimed herein.

The tool according to the invention is characterized in that the radial cutting tooth profile boundary of the cutting teeth is entirely (or at least sectionally) curved in the starting region and/or in the guide region.

The advantages of the invention are in particular that, on account of the provision of curvatures in the cutting tooth profile boundary, the wear to the cutting teeth is reduced. As a result of the curvatures, wear-susceptible rectilinear profile boundaries, or profile boundaries that have edges, are avoided or at least reduced, and the curved profile boundaries are much less wear-susceptible. Thus, the service life of the tool according to the invention is increased compared with similar known tools.

Further advantages arise in the thread produced using the tool according to the invention. Compared with threads produced using known tools, this thread has a very smooth surface. Furthermore, the thread produced likewise has, as a negative of the tool, curvatures in its cross-sectional profile, in particular it is rounded in the region of its outside diameter. As a whole, the thread has a lower notch effect than a thread produced with a similar known tool.

A development of the invention provides that the profile differential area of two axially spaced-apart cutting teeth has two boundary lines in the starting region that are spaced apart radially to the tool axis and are entirely (or at least sectionally) curved.

The advantages of this development are in particular the shape of the chip which arises on account of the at least sectionally curved boundary lines of the profile differential area. As a result, the chip does not have a rectangular or trapezoidal cross section, but a cross section provided with curvatures in a manner corresponding to the profile differential area. A curved chip is thus produced.

A development of the invention provides that the shortest distance of each point of the radially internal boundary line of the profile differential area from the radially external boundary line of the profile differential area is constant along the entire internal boundary line or along at least a section of the internal boundary line, in particular along a curved section. Thus, the profile differential area has a constant thickness as a whole (or at least sectionally), such that a chip produced by the following cutting tooth in a manner corresponding to this profile differential area is not only entirely or sectionally curved, but likewise has substantially a constant thickness in its entire cross section or sectionally.

Provision can also be made for the shortest distance of each point of the radially internal boundary line of the profile differential area from the radially external boundary line of the profile differential area to increase or decrease along the entire internal boundary line or along at least a section of the internal boundary line, in particular along a curved section. Accordingly, the profile differential area has a varying thickness as a whole (or at least sectionally). This shape is also reproduced in the cross section of the chip produced by the following cutting tooth.

According to a development, the profile differential areas between in each case two axially spaced-apart cutting teeth increase with increasing axial distance between the two cutting teeth. Thus, the further the two cutting teeth set in relation to one another are apart axially, the greater the profile differential area of this cutting tooth pair in question becomes.

According to one configuration of the invention, the cutting tooth head of the cutting tooth of which the radial cutting tooth profile boundary defines the radially internal boundary line of the profile differential area is arranged substantially centrally between two cutting tooth flanks of the cutting tooth of which the radial cutting tooth profile boundary defines the radially external boundary line of the profile differential area.

However, it is also possible for the cutting tooth head of the cutting tooth of which the radial cutting tooth profile boundary defines the radially internal boundary line of the profile differential area to be arranged at a distance from the centre between two cutting tooth flanks of the cutting tooth of which the radial cutting tooth profile boundary defines the radially external boundary line of the profile differential area.

The abovementioned configurations result in corresponding shapes of the respective profile differential areas and thus of the cross sections of the chips produced. For example, a central arrangement can result in a minor-symmetrical profile differential area and an eccentric arrangement can result in a non-symmetrical profile differential area. The cross sections of the chips produced each have a corresponding shape.

The cutting teeth can be arranged for example in two or more planes perpendicularly to the tool axis, these planes being spaced apart from one another, specifically in a manner corresponding to the pitch of the thread to be produced. However, it is also possible for the cutting teeth to be arranged along an external thread, encircling the tool axis, at the thread pitch of the thread to be produced. The abovementioned profile differential area, which is also reproduced in the cross section of a produced chip, is then a profile differential area between two successive cutting teeth along the external thread in the starting region. The profile differential areas between in each case two successive cutting teeth along the external thread may be for example constant or increase counter to the intended feed direction of the tool in the starting region.

A development of the invention provides that the cutting teeth are arranged on a tool core.

In this case, provision can be made for the circumferential radius of the tool core to increase counter to the intended feed direction of the tool in the starting region. In this case, reference is made to what is known as a tapered end. The height of the cutting teeth over the tool core can be configured both in a constant manner and in a manner increasing counter to the intended feed direction of the tool in the starting region. The increase in the radial distance of the cutting tooth heads from the tool axis counter to an intended feed direction of the tool in the starting region is achieved in any case by the increase in the circumferential radius of the tool core and optionally supported, if correspondingly realized, by the increase in the height of the cutting teeth over the tool core.

Provision can also be made for the circumferential radius of the tool core to be substantially constant in the starting region, and for the height of the cutting tooth heads over the tool core to increase counter to the intended feed direction of the tool in the starting region. The increase in the radial distance of the cutting tooth heads from the tool axis counter to an intended feed direction of the tool in the starting region is achieved in this case by the increase in the height of the cutting teeth over the tool core.

Alternatively or in addition to the above-described variants, provision can be made for the circumferential radius of the tool core to decrease counter to the intended feed direction of the tool in the guide region, wherein the decrease preferably turns out to be less strong than the optionally provided increase in the starting region. Alternatively, the circumferential radius of the tool core can also be substantially constant in the guide region. In this case, the height of the cutting tooth heads over the tool core can be substantially the same or decrease counter to the intended feed direction of the tool in the guide region, wherein the decrease again preferably turns out to be less strong than the optionally provided increase in the starting region.

A configuration of the invention provides that the radius or the radii of the curvature of the radial cutting tooth profile boundary of the cutting teeth is/are between 4/10 and 8/10 of the height of the highest cutting tooth over the tool core in the starting region and/or in the guide region.

The tool can also be configured such that the profiles of the cutting teeth correspond to one another in terms of their shape in the starting region and/or in the guide region.

Provision can be made for the radius of the curvature of the radial cutting tooth profile boundary of the cutting teeth to be constant in the starting region and/or in the guide region. Alternatively thereto, the radius of the curvature of the radial cutting tooth profile boundary of the cutting teeth can also have a different radius, in particular a larger radius, in a central section of each tooth head than the curvatures in one or both transitional regions to adjoining tooth flanks of each cutting tooth in the starting region and/or in the guide region.

According to a development, provision can be made for the cutting tooth profile boundary to have a bend. Alternatively, however, one or more bends may also be provided. In particular, at least one bend can be provided for example at the transition from the tooth head to one or both adjoining tooth flanks. However, the transition can also be formed without a bend.

The method according to the invention provides for the use of the above-described tool according to the invention in any desired embodiment. In this method, the cutting teeth, as already explained, produce curved chips in the starting region.

The advantages of this method can be gathered from the description of the tool according to the invention.

### BRIEF DESCRIPTION OF THE DRAWINGS

The invention is explained in more detail in the following text, also with regard to further features and advantages, by way of the description of exemplary embodiments and with reference to the appended schematic drawings, in which:

FIG. 1 shows an axial cross-sectional illustration of an example of a tool according to the invention;

FIG. 2 shows an example of a profile differential surface between two profiles, superimposed in axial cross section, of two axially spaced-apart cutting teeth; and

FIG. 3 shows a further example of a profile differential area between two profiles, superimposed in axial cross section, of two axially spaced-apart cutting teeth.

Mutually corresponding parts and components are designated with the same reference signs in the figures.

### DETAILED DESCRIPTION OF THE PREFERRED EMBODIMENTS

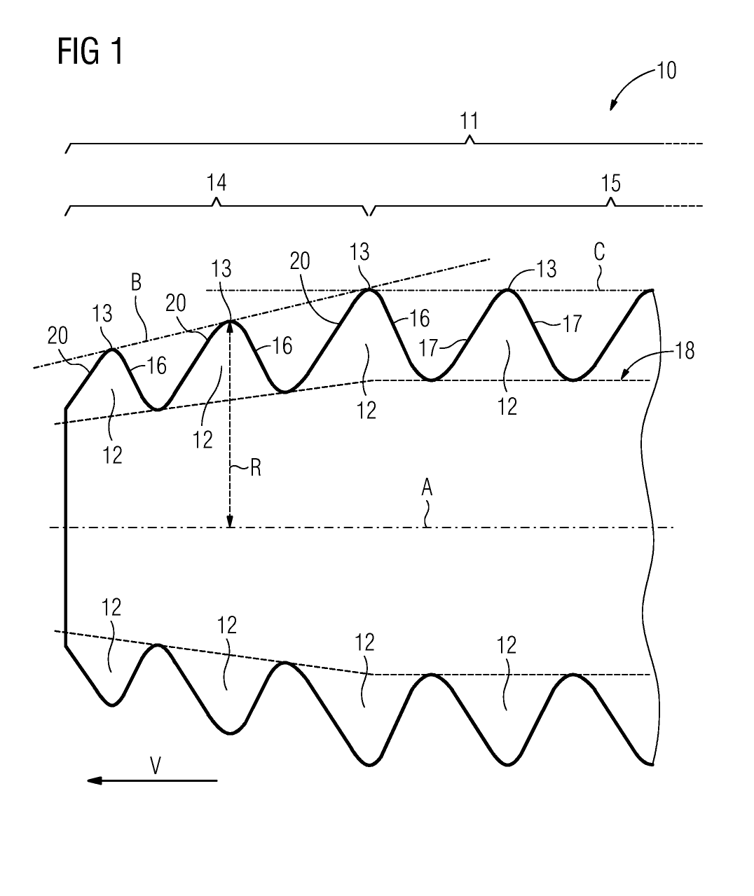

FIG. 1 shows an axial cross-sectional illustration of an exemplary embodiment of a tool according to the invention 10 for cutting thread production. The tool 10 comprises a working region 11 that is rotatable or rotated about a tool axis A and has a plurality of cutting teeth 12 arranged on the tool circumference. Specifically, this is a tap or a thread milling cutter, in which two or more cutting teeth 12 are arranged in planes perpendicularly to the tool axis A, wherein these planes are spaced apart, specifically in a manner corresponding to the pitch of the thread to be produced.

However, tools according to the invention, in particular taps, can, alternatively thereto, also be configured such that the cutting teeth are arranged along an external thread at the thread pitch of the thread to be produced. The following explanations apply in an analogous manner to such tools.

The working region 11 is subdivided into a starting region 14 and a guide region 15, wherein the starting region 14 is in front of the guide region 15 in an intended feed direction V of the tool, that is to say the cutting teeth 12 of the starting region 14 come into working engagement with a workpiece to be machined before the cutting teeth 12 of the guide region 15.

In the tool 10 in FIG. 1, each cutting tooth 12 has a cutting tooth head 13 at its point or region that is radially farthest from the tool axis A, said cutting tooth head 13 being arranged between two cutting tooth flanks 17 of the respective cutting tooth 12. In the starting region 14, the radial distance R of the cutting tooth heads 12 increases from the tool axis A counter to the intended feed direction V of the tool 10. This is apparent in FIG. 1 from the cutting head straight line B in the starting region 14, said cutting head straight line B being inclined with respect to the tool axis A. By contrast, in the guide region 15, the radial distance R of the cutting tooth heads 12 from the tool axis A is substantially constant. Accordingly, the cutting head straight line C indicated in FIG. 1 extends parallel to the tool axis A in the guide region 15.

The cutting teeth 12 are arranged on a tool core 18, wherein, in the example shown in FIG. 1, the circumferential radius of the tool core 18 increases counter to the intended feed direction V of the tool 10 in the starting region 14 and is constant in the guide region 14. There is thus what is known as a tapered end in the starting region 14. In the example shown, the height of the cutting tooth heads 13 over the tool core 18 increases counter to the intended feed direction V, but it would also be possible to configure the height of the cutting tooth heads 13 to be constant in the starting region 14, wherein, in this case, the increase in the radial distance R of the cutting tooth heads 13 from the tool axis A counter to the intended feed direction V is brought about solely by the change in the circumferential radius of the tool core 18.

Alternatively, it is also possible to configure the circumferential radius of the tool core 18 to be substantially constant in the starting region 14 and identical to the guide region 15. In this case, the increase in the radial distance R of the cutting tooth heads 13 from the tool axis A counter to the intended feed direction V is realized solely by a corresponding increase in the height of the cutting tooth heads 13 over the tool core 18. Typically, this is achieved by what is known as a chamfer in the starting region 14.

Alternatively to the illustration in FIG. 1, the circumferential radius of the tool core 18 could also decrease counter to the intended feed direction V of the tool 10 in the guide region 15. In this case, the radial distance R of the cutting tooth heads 13 from the tool axis A could likewise decrease counter to the intended feed direction V of the tool 10.

It is further possible that, although the circumferential radius of the tool core 18 is substantially constant in the guide region 15, the height of the cutting tooth heads 13 over the tool core 18 decreases counter to the feed direction V of the tool 10.

It can be seen in FIG. 1 that the radial cutting tooth profile boundary 20 of the cutting teeth 12 is entirely (or at least sectionally) curved in the starting region 14 and also in the guide region 15.

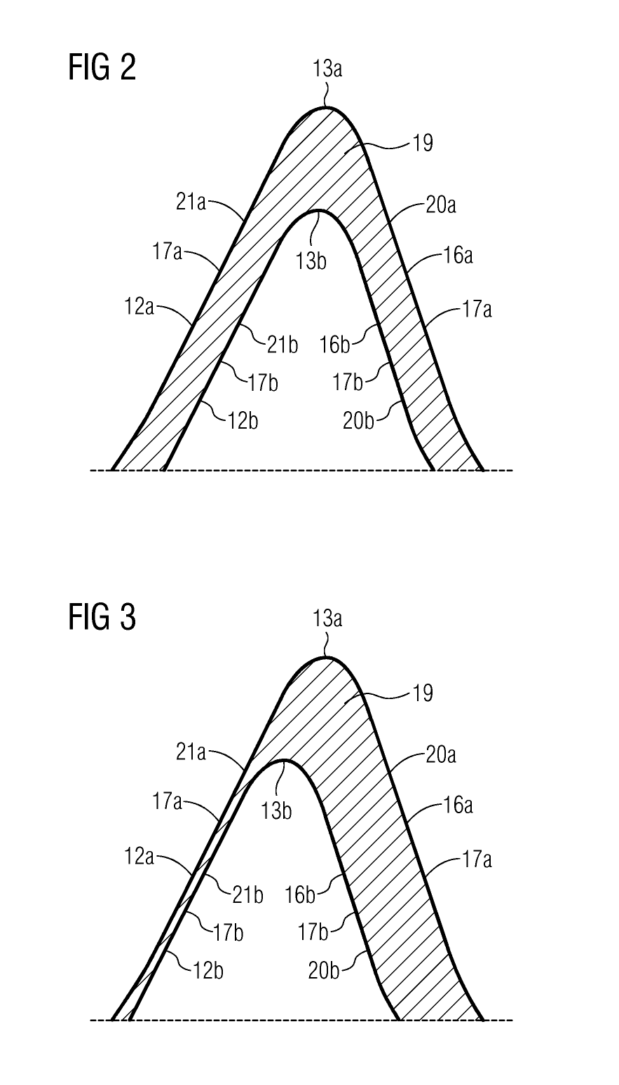

If the profiles 16 of axially spaced-apart cutting teeth 12 in the starting region 14 are superimposed in an axial cross section, that is to say in a cross section parallel to the tool axis A, which contains the tool axis A, a profile differential area 19 (not illustrated in FIG. 1, see FIG. 2 and FIG. 3) is produced between the profile 16. This profile differential area 19 is explained in more detail in the following text with reference to FIG. 2 and FIG. 3.

FIG. 2 and FIG. 3 show two different examples of a profile differential area 19 between two profiles 16a, 16b, superimposed in axial cross section, of two axially spaced-apart cutting teeth 12a, 12b in the starting region 14. In both cases, the cutting tooth head 13a of the cutting tooth 12a that is located at the rear in the viewing direction has a greater height over the tool core 18 than the cutting tooth head 13b of the cutting tooth 12b that is located at the front and thus in front of the abovementioned cutting tooth 12a in the viewing direction. A profile differential area 19 thus arises in the plane of the drawing, both in FIG. 2 and FIG. 3, between the radial cutting tooth profile boundary 20a of the cutting tooth 12a located at the rear and the cutting tooth boundary 20b of the cutting tooth 12b located at the front. The radial cutting tooth profile boundary 20a of the cutting tooth 12a located at the rear forms a boundary line 21a of the profile differential area 19, and the radial cutting tooth profile boundary 20b of the cutting tooth 12b located at the front forms a further boundary line 21b of the profile differential area 19. The two boundary lines 21a and 21b are spaced apart radially with respect to the tool axis A. Both boundary lines are at least sectionally curved.

In FIG. 2 and in FIG. 3, the profiles 16a, 16b of the cutting teeth 12a, 12b, illustrated respectively one behind the other, in the starting region 14 correspond to one another in terms of their shape. However, this is not necessarily the case, and a large variety of configurations are possible in which the profiles 16a, 16b do not correspond to one another in terms of their shape.

If the cutting teeth 12a, 12b, located one behind the other in FIG. 2 and FIG. 3, come into working use directly in succession at the same region of a workpiece, first the cutting tooth 12a located at the front and then the cutting tooth 12b located at the rear, the chip removed by the rear cutting tooth 12b corresponds in terms of its cross section at least substantially to the profile differential area 19. A curved chip is thus formed.

In the exemplary embodiment according to FIG. 2, the cutting tooth head 13a of the cutting tool 12b located at the rear is arranged substantially centrally between two cutting tooth flanks 17a of the cutting tooth 12a located at the front. This results in a chip which has a substantially identical thickness over its entire width; only in the region of the cutting tooth heads 13a, 13b is the chip somewhat thicker than in the peripheral regions.

In the exemplary embodiment according to FIG. 3, the cutting tooth head 13a of the cutting tooth 12b located at the rear is arranged at a distance from the centre between the two cutting edge flanks 17a, 17b of the cutting tooth 12a located at the front. This results in a chip which is formed in a considerably narrower manner at one side (on the left in FIG. 3) than in the centre at the cutting tooth heads 13a, 13b and on its other side (on the right in FIG. 3).

Numerous further configurations of the cutting teeth 12a and 12b assigned to one another in accordance with FIG. 2 and FIG. 3 are possible, wherein the respective profiles 16a and 16b and thus the respective radial cutting tooth profile boundaries 20a and 20b result in profile differential areas 19 having corresponding boundary lines 21a and 21b.

For example, the shortest distance of each point on the radially internal boundary line 21b of the profile differential area 19 from the radially external boundary line 21a of the profile differential area 19 can be constant along the entire internal boundary line 21b or along at least a section of the internal boundary line 21b, in particular along a curved section.

Also, the shortest distance of each point on the radially internal boundary line 21b of the profile differential area 19 from the radially external boundary line 21a of the profile differential area 19 can increase or decrease along the entire internal boundary line 21b or along at least a section of the internal boundary line 21b, in particular along a curved section.

Provision can be made for the profile differential areas 19 between in each case two axially spaced-apart cutting teeth 12a, 12b to increase with increasing axial distance between the two cutting teeth 12a, 12b.

The cross sections of the chips produced with these configurations each have a configuration corresponding to the respective profile differential area.

The present invention may be embodied in other specific forms without departing from its spirit or essential characteristics. For example, the flexible dies can include flexible protrusions on both the front and back surfaces. Thus, a single flexible die can form recesses into surfaces of two different panels at the same time. Furthermore, the panels can include recesses in both the front and back surfaces. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### LIST OF REFERENCE SIGNS

10 Tool
11 Working region
12, 12a, 12b Cutting tooth
13, 13a, 13b Cutting tooth head
14 Starting region
15 Guide region
16, 16a, 16b Profile of the cutting tooth 12
17, 17a, 17b Cutting tooth flank
18 Tool core
19 Profile differential area
20, 20a, 20b Radial cutting tooth profile boundary
21a, 21b Boundary lines of the profile differential area 19
A Tool axis
B Cutting head straight line in the starting region 14
C Cutting head straight line in the guide region 15
R Radial distance of the cutting tooth head 13 from the tool axis A
V Intended feed direction

We claim:

1. Tool for cutting thread production, in particular a tap, comprising:
at least one working region of the tool that is rotatable or rotated about a tool axis (A); and
a plurality of cutting teeth arranged on the tool circumference in the at least one working region of the tool,
wherein:
each cutting tooth has a cutting tooth head at its point or region that is radially farthest from the tool axis (A);
the radial distance (R) of the cutting tooth heads from the tool axis (A) is substantially the same or decreases counter to an intended feed direction (V) of the tool (10) in a guide region of the working region;
the radial distance (R) of the cutting tooth heads from the tool axis (A) increases counter to the intended feed direction (V) of the tool in a starting region, located in front of the guide region in the intended feed direction, of the working region, such that, in an axial cross section, the superimposed profiles of axially spaced-apart cutting teeth have a profile differential area; and
the radial cutting tooth profile boundary of the cutting teeth is entirely or at least sectionally curved in the starting region and/or in the guide region.

2. The tool as recited in claim 1, wherein the profile differential area of two axially spaced-apart cutting teeth has two boundary lines in the starting region that are spaced apart radially to the tool axis (A) and are entirely or at least sectionally curved.

3. The tool as recited in claim 2, wherein the shortest distance of each point of the radially internal boundary line of the profile differential area from the radially external boundary line of the profile differential area is constant along one of:
the entire internal boundary line; or
at least a section of the internal boundary line, in particular along a curved section.

4. The tool as recited in claim 2, wherein the shortest distance of each point of the radially internal boundary line of the profile differential area from the radially external boundary line of the profile differential area changes along one of:
the entire internal boundary line; or
at least a section of the internal boundary line, in particular along a curved section.

5. The tool as recited in claim 2, wherein the profile differential areas between in each case two axially spaced-apart cutting teeth increase with increasing axial distance between the two cutting teeth.

6. The tool as recited in claim 2, wherein the cutting tooth head of the cutting tooth of which the radial cutting tooth profile boundary defines the radially internal boundary line of the profile differential area is arranged substantially centrally between two cutting tooth flanks of the cutting tooth of which the radial cutting tooth profile boundary defines the radially external boundary line of the profile differential area.

7. The tool as recited in claim 2, wherein the cutting tooth head of the cutting tooth of which the radial cutting tooth profile boundary defines the radially internal boundary line of the profile differential area is arranged at a distance from the centre between two cutting tooth flanks of the cutting tooth of which the radial cutting tooth profile boundary defines the radially external boundary line of the profile differential area.

8. The tool as recited in claim 2, wherein:
the cutting teeth are arranged along an external thread, encircling the tool axis, at the thread pitch of the thread to be produced; and
the profile differential area is a profile differential area between two successive cutting teeth along the external thread in the starting region.

9. The tool as recited in claim 8, wherein the profile differential areas between in each case two successive cutting teeth along the external thread are constant or increase counter to the intended feed direction (V) of the tool in the starting region.

10. The tool as recited in claim 1, wherein the cutting teeth are arranged on a tool core.

11. The tool as recited in claim 10, wherein the circumferential radius of the tool core increases counter to the intended feed direction (V) of the tool in the starting region.

12. The tool as recited in claim 10, wherein:
the circumferential radius of the tool core is substantially constant in the starting region; and
the height of the cutting tooth heads over the tool core increases counter to the intended feed direction (V) of the tool in the starting region.

13. The tool as recited in claim 10, wherein the circumferential radius of the tool core decreases counter to the intended feed direction (V) of the tool (10) in the guide region.

14. The tool as recited in claim 10, wherein:
the circumferential radius of the tool core is substantially constant in the guide region (15), and
the height of the cutting tooth heads over the tool core is substantially the same or decreases counter to the intended feed direction (V) of the tool in the guide region.

15. The tool as recited in claim 10, wherein the radius or the radii of the curvature of the radial cutting tooth profile boundary of the cutting teeth is/are between 4/10 and 8/10 of the height of the highest cutting tooth over the tool core in the starting region and/or in the guide region.

16. The tool as recited in claim 1, wherein the profiles of the cutting teeth correspond to one another in terms of their shape in the starting region and/or in the guide region.

17. The tool as recited in claim 1, wherein the radius of the curvature of the radial cutting tooth profile boundary of the cutting teeth is constant in the starting region and/or in the guide region.

18. The tool as recited in claim 1, wherein the radius of the curvature of the radial cutting tooth profile boundary the cutting teeth has a different radius, in particular a larger radius, in a central section of each tooth head than the curvatures in one or both transitional regions to adjoining tooth flanks of each cutting tooth in the starting region and/or in the guide region.

19. A method for cutting thread production using a tool as recited in claim 1, wherein the cutting teeth produce curved chips in the starting region.
